(19) United States
(12) Patent Application Publication
(10) Pub. No.: US 2013/0200994 A1
(43) Pub. Date: Aug. 8, 2013

(54) WIRELESS SYSTEMS AND METHODS OF MAKING VISITOR APPOINTMENTS

(71) Applicant: Kamal Kannan, Madurai (IN)

(72) Inventor: Kamal Kannan, Madurai (IN)

(73) Assignee: Honeywell International Inc., Morristown, NJ (US)

(21) Appl. No.: 13/366,927

(22) Filed: Feb. 6, 2012

(51) Int. Cl. G05B 23/00

(52) U.S. Cl. 340/5.2

(57) ABSTRACT

Wireless systems and methods for making visitor appointments are provided. Methods include wirelessly transmitting a registration form to a visitor device, wirelessly receiving a completed registration form from the visitor device, validating a visitor, wirelessly transmitting an image to the visitor device, wirelessly receiving an appointment request from a visitor device, processing the appointment request, wirelessly transmitting a message with available appointment times to the visitor device, wirelessly receiving an approval request from the visitor device, and wirelessly transmitting an approval confirmation message to the visitor device.

### FIELD

The present invention relates generally to visitor management systems. More particularly, the present invention relates to wireless systems and methods for making visitor appointments.

### BACKGROUND

In many large buildings and facilities, for example, corporate or manufacturing facilities, security is important. Thus, many large buildings employ visitor management systems to handle a guest's check in process, for example, obtaining an appointment with an employee of the building.

For example, in known visitor management systems, when a guest or visitor arrives at a building, he must check in with security to obtain an appointment with an employee of the building. Because physical presence and verification is required, the guest cannot remotely obtain an appointment before arriving at the building. When checking in, the guest must present identification and be confirmed by security and/or by an employee/host who is meeting with the guest. If the host has not confirmed the guest prior to his visit, security may contact the host to separately confirm the guest.

When a person is a repeated guest of a building, for example, a contractor or privileged visitor, the check in process for obtaining an appointment can become tedious and time consuming. Even if a person is not a repeated guest of a building, the check in process for obtaining an appointment can be tedious and time consuming. For example, there may be a line to check in when several guests arrive at a building simultaneously. Further, the guest may experience a wait while security contacts a potential host to confirm the guest.

There is thus a continuing, ongoing need for improved wireless systems and methods for making visitor appointments.

### BRIEF DESCRIPTION OF THE DRAWINGS

FIG. 1 is a flow diagram of a method of wirelessly making a visitor appointment in accordance with embodiments disclosed herein; and

FIG. 2 is a block diagram of a system for carrying out the method of FIG. 1 and others disclosed herein.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include improved wireless systems and methods for making visitor appointments. For example, an appointment registration form can be wirelessly transmitted to the mobile device of a visitor to a building. In some embodiments, the appointment registration form can be wirelessly transmitted via short message services (SMS) using, for example, near field communication (NFC) and/or Bluetooth technology.

It is to be understood that the visitor's mobile device does not limit the embodiments disclosed herein. Rather, the visitor's mobile device can be any mobile device as in known in the art, including, but not limited to, a cellular phone, a smart phone, a personal digital assistant, and any other handheld device as would be known by those of skill in the art.

It is also to be understood that the technology employed for the wireless transmissions described herein does not limit the embodiments disclosed herein. Rather, the technology employed for wirelessly transmitting a registration form, a completed registration form, a badge, a password, an appointment request, a message with available time for an employee, an approval request, and an approval confirmation message can each be sent between a visitor's mobile device and systems disclosed herein using technology, including, but not limited to, SMS, NFC, Bluetooth, interactive voice response systems (IVRS), web-based systems, GSM, and the like.

According to embodiments described herein, when a new visitor arrives at a building, a registration form can be wirelessly transmitted to the visitor's mobile device. In some embodiments, the registration form can be sent to the visitor's mobile device while the visitor is entering the building or substantially immediately after the visitor enters the building, for example, when the visitor is in the lobby or in the front office of the building.

When the visitor receives the registration form on his mobile device, the visitor can complete the registration form using his mobile device. For example, the visitor can enter into his mobile phone the data required by the registration form. When all of the required data is entered, the visitor can submit, that is wirelessly transmit, the completed registration form from his mobile device to systems disclosed herein and employed by the building.

When systems and methods according to embodiments disclosed herein receive a completed registration form from a visitor's mobile device, systems and methods can process the form and confirm or validate the visitor. When the visitor is confirmed or validated, systems and methods can wirelessly transmit an image to the visitor's mobile device. In some embodiments the image transmitted to the visitor's mobile device can be encrypted, and in some embodiments, the image can include a visitor badge. In some embodiments, a key or password can also be wirelessly transmitted to the visitor's mobile device, and in some embodiments, the key or password can also be encrypted.

In some embodiments, the badge and/or key transmitted the, visitor's mobile device can be used by the visitor to traverse the building. For example, the badge and/or key transmitted the visitor's mobile device can include those described and disclosed in U.S. application Ser. No. 13/151,580 titled “Establishing an E-Badge Via Mobile Pre-Registration for a Visitor Management System.” U.S. application Ser. No. 13/151,580 is assigned to the assignee hereof and is hereby incorporated by reference.

For example, the badge and/or key can include a temporary access badge displayed directly on the visitor's mobile device. In some embodiments, the badge and/or key displayed on the visitor's mobile device can include a machine-readable representation of data, for example a barcode, that represents information about the visitor. Accordingly, the visitor can use the badge and/or key on his mobile device to check in with security and/or to open doors associated with access points throughout the building.

In accordance with disclosed embodiments, systems and methods described herein can register multiple visitors of a building substantially simultaneously, thus, speeding up the registration process for a visitor and eliminating long lines for registration. That is, systems and methods disclosed herein can transmit a plurality registration forms to a plurality of different visitor mobile devices substantially simultaneously. Systems and methods can also process, confirm, and validate a plurality of completed registration forms substantially simultaneously and transmit a plurality of images, badges, and/or passwords to a plurality of different visitor mobile devices substantially simultaneously.

Systems and methods disclosed herein can include a database and/or server of available time or time slots for employees of the building. For example, employees can enter and/or provide their available time to indicate their available time or time slots throughout a day. In some embodiments, systems and methods for employees entering their available time can be web-based. In some embodiments, employees can enter their available time via a user interface of a personal computer, for example, a desktop computer at the employees' desks.

The available time or time slots of employees in the building can be maintained and updated in a database and/or server. Thus, when a visitor to the building requests an appointment with an individual employee, systems and methods can determine if and when that employee is available for a meeting with the visitor.

For example, in some embodiments, after a visitor to a building completes the registration process, that is, after the visitor wirelessly receives his badge and/or key on his mobile device, the visitor, via his mobile phone, can wirelessly transmit a request for an appointment with a particular employee of the building. Systems and methods can process the appointment request, access the database and/or server to determine the available time for the employee, and wirelessly transmit to the visitor's mobile device, a message with the available time for the employee. In some embodiments, systems and methods can verify the visitor's key or password before wirelessly transmitting the message with the available time for the employee.

In accordance with disclosed embodiments, after the visitor's mobile device receives the employee's available time, the visitor, via his mobile device, can wirelessly transmit a request for approval of an appointment during at least one of the employee's available time slots. Systems and methods can transmit the request for approval to the employee, and when approved by the employee, systems and methods can wirelessly transmit an approval confirmation message to the visitor's mobile device confirming the appointment during the relevant time slot.

As explained above, systems and methods described herein can be web-based. Accordingly, in some embodiments, visitors to the building and their mobile devices need not be physically present in the building to wirelessly receive a registration form, wirelessly transmit a completed registration form, wirelessly receive a badge and key, wirelessly transmit an appointment request, wirelessly receive a message with available appointment times of an employee, wirelessly transmit an approval request, and/or wirelessly receive an approval confirmation message. Similarly, employees of the building need not be physically present in the building to enter their available time, receive an approval request, and/or transmit an approval message.

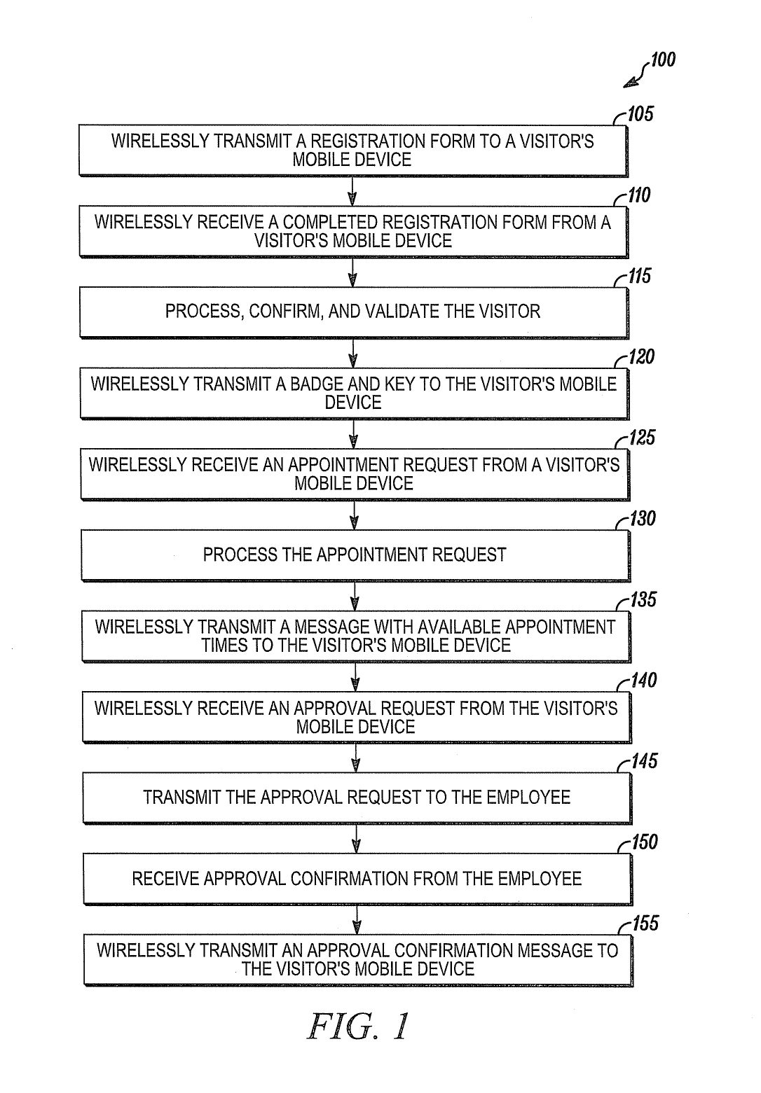

FIG. 1 is a flow diagram of a method 100 of wirelessly making a visitor appointment in accordance with embodiments disclosed herein. As seen in FIG. 1, the method 100 can include wirelessly transmitting a registration from to a visitor's mobile device as in 105. The method 100 can wirelessly receive a completed registration form from the visitor's mobile device as in 110 and then process, confirm, and validate the visitor as in 115. When the visitor is confirmed, the method 100 can wirelessly transmit a badge and key to the visitor's mobile device as in 120.

The method 100 can also include wirelessly receiving an appointment request from a visitor's mobile device as in 125 and processing the appointment request as in 130. Processing the appointment request can include accessing a database and/or server to determine available time for the employee requested in the appointment request. Then, the method 100 can wirelessly transmit a message with available appointment times for that employee to the visitor's mobile device as in 135.

The method 100 can wirelessly receive an approval request from a visitor's mobile device as in 140 and transmit the approval request to the employee as in 145. When the method 100 receives approval confirmation from the employee as in 150, the method 100 can wirelessly transmit an approval confirmation message to the visitor's mobile device as in 155.

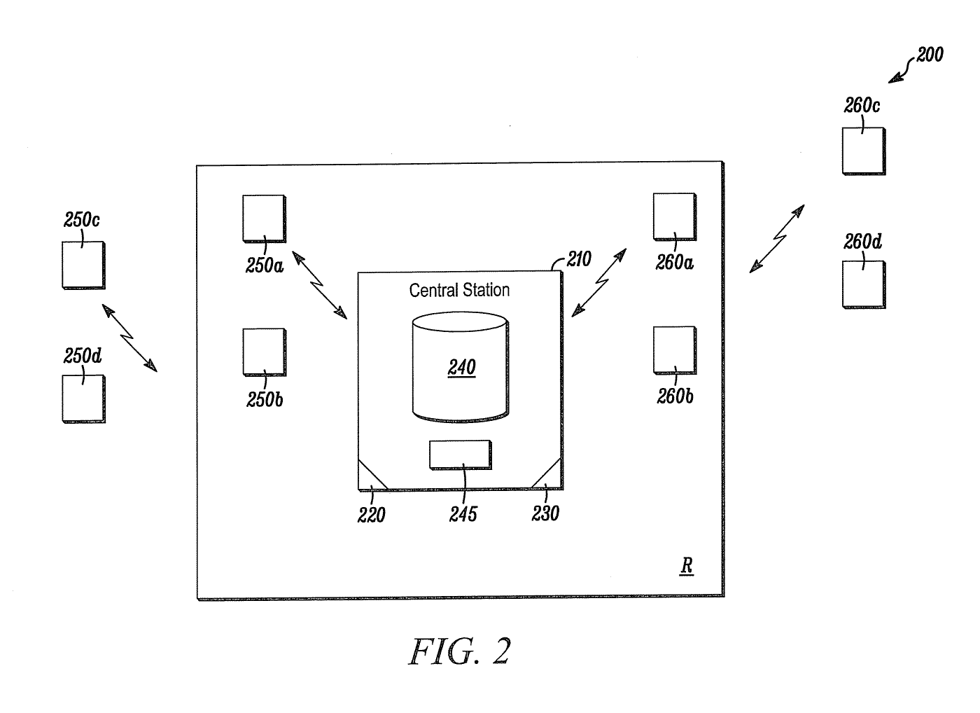

The method shown in FIG. 1 and others disclosed herein can be implemented with a system 200. As seen in FIG. 2, the system 200 can include a server or central station 210 that includes a transceiver 245, one or more programmable processors 220, and executable control software 230 as would be understood by those of ordinary skill in the art. In some embodiments, the central station 210 can include a memory device 240, for example, a database or server.

The executable control software 230 can implement the method shown and described in FIG. 1 as well as others described herein. Further, the executable control software 230 can be stored on a transitory or non-transitory local computer readable medium, including, but not limited to, local computer memory, RAM, optical storage media, magnetic storage media, flash memory, etc.

As seen in FIG. 2, the system 200 can also include a plurality of visitor devices 250a, 250b, 250c, 250d and employee devices 260a, 260b, 260c, 260d. For example, a visitor device 250a, 250b, 250c, 250d can include a visitor's mobile and/or handheld device. An employee device 260a, 260b, 260c, 260d can include, for example, an employee's mobile and/or handheld device or personal and/or desktop computer.

Each of the visitor devices 250a, 250b, 250c, 250d can be in wired or wireless communication with the central station 210. Similarly, each of the employee devices 260a, 260b, 260c, 260d can be in wired or wireless communication with the central station 210.

As seen in FIG. 2, visitor devices 250a, 250b can be within building region R and communicate with the central station 210. Alternatively, visitor devices 250c, 250d can be outside of the building region R and communicate with the central station 210. Similarly, employee device 260a, 260b can be within the building region R and communicate with the central station 210, and employee devices 260c, 260d can be outside of the building region R and communicate with the central station 210.

In accordance with embodiments disclosed herein, the central station 210 can wirelessly register a visitor to the building and wirelessly schedule an appointment for the visitor with an employee of the building. For example, the central station 210 can wirelessly transmit a registration form to a visitor device 250a, 250b, 250c, 250d, wirelessly receive a completed registration form from a visitor device 250a, 250b, 250c, 250d, process, confirm, and validate a visitor, and wirelessly transmit a badge and key to a visitor device 250a, 250b, 250c, 250d. The central station 210 can also wirelessly receive an appointment request from a visitor device 250a, 250b, 250c, 250d, process the appointment request, for example, by searching the database 240, wirelessly transmit a message with available appointment times to a visitor device 250a, 250b, 250c, 250d, wireless receive an approval request from a visitor device 250a, 250b, 250c, 250d, transmit the approval request to an employee device 260a, 260b, 260c, 260d, receive approval confirmation from the employee device 260a, 260b, 260c, 260d, and wirelessly transmit an approval confirmation message to a visitor device 250a, 250b, 250c, 250d.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. A method comprising:
wirelessly transmitting a registration form to a visitor device;
wirelessly receiving a completed registration form from the visitor device;
validating a visitor;
wirelessly transmitting an image to the visitor device;
wirelessly receiving an appointment request from a visitor device;
processing the appointment request;
wirelessly transmitting a message with available appointment times to the visitor device;
wirelessly receiving an approval request from the visitor device; and
wirelessly transmitting an approval confirmation message to the visitor device.

2. The method of claim 1 wherein the visitor device includes one of a mobile device, a cellular phone, a personal digital assistant, and a handheld device.

3. The method of claim 1 wherein wirelessly transmitting and wirelessly receiving is via one of SMS, NEC, Bluetooth, IVRS, GSM, and a web-based system.

4. The method of claim 1 wherein wirelessly transmitting the registration form to a visitor device includes wirelessly transmitting the registration form while the visitor enters a secured building or substantially immediately after the visitor enters the secured building.

5. The method of claim 1 wherein wirelessly transmitting the image to the visitor device includes encrypting the image before wirelessly transmitting the image to the visitor device.

6. The method of claim 1 wherein wirelessly transmitting the image to the visitor device includes wirelessly transmitting at least one of a visitor badge, a temporary access badge, a key, a password, and a machine readable representation of data to the visitor device.

7. The method of claim 1 further comprising displaying the image directly on the visitor device.

8. The method of claim 1 further comprising:
wirelessly transmitting a registration form to a plurality of visitor devices substantially simultaneously;
wirelessly receiving a completed registration form from at least some of the plurality of visitor devices substantially simultaneously;
validating a plurality of visitors substantially simultaneously; and
wirelessly transmitting an image to at least some of the plurality of visitor devices substantially simultaneously.

9. The method of claim 1 further comprising:
wirelessly receiving an appointment request from a plurality of visitor devices substantially simultaneously;
processing the appointment requests substantially simultaneously;
wirelessly transmitting a message with available appointment times to at least some of the plurality of visitor devices substantially simultaneously;
wirelessly receiving an approval request from at least some of the plurality of visitor devices substantially simultaneously; and
wirelessly transmitting an approval confirmation message to at least some of the plurality of visitor devices substantially simultaneously.

10. The method of claim 1 wherein processing the appointment request includes accessing a database to determine the available appointment times for an employee of a building.

11. The method of claim 1 further comprising verifying the image on the visitor device before wirelessly transmitting the message with available appointment times to the visitor device.

12. The method of claim 1 further comprising transmitting the approval request to an employee device and receiving an approval confirmation from the employee device before wirelessly transmitting the approval confirmation message to the visitor device.

13. A method comprising:
maintaining a database of available appointment times for employees of a building;
receiving, from an employee device, information about available time for an employee of the building;
updating the database with the information about the available time for the employee of the building;
wirelessly receiving an appointment request from a visitor device to schedule an appointment with the employee of the building;
accessing the database to determine the available time for the employee of the building;
wirelessly transmitting, to the visitor device, a message with the available time for the employee of the building;
wirelessly receiving an approval request from the visitor device;
transmitting the approval request to the employee device;
receiving an approval confirmation from the employee device; and
wirelessly transmitting an approval confirmation message to the visitor device.

14. The method of claim 13 further comprising verifying the visitor device before wireless transmitting, to the visitor device, the message with the available time for the employee of the building.

15. A system comprising:
a transceiver;
a programmable processor; and
executable software stored on a non-transitory computer readable medium for:
wirelessly transmitting, via the transceiver, a registration form to a visitor device;
wirelessly receiving, via the transceiver, a completed registration form from the visitor device;
validating a visitor;
wirelessly transmitting, via the transceiver, an image to the visitor device;
wirelessly receiving, via the transceiver, an appointment request from a visitor device;
processing the appointment request;
wirelessly transmitting, via the transceiver, a message with available appointment times to the visitor device;
wirelessly receiving, via the transceiver, an approval request from the visitor device; and
wirelessly transmitting, via the transceiver, an approval confirmation message to the visitor device.

16. The system of claim 15 wherein the executable control software encrypts the image before wirelessly transmitting the image to the visitor device.

17. The system of claim 15 wherein the executable control software:
wirelessly transmits, via the transceiver, a registration form to a plurality of visitor devices substantially simultaneously;
wirelessly receives, via the transceiver, a completed registration form from at least some of the plurality of visitor devices substantially simultaneously;
validates a plurality of visitors substantially simultaneously; and
wirelessly transmits, via the transceiver, an image to at least some of the plurality of visitor devices substantially simultaneously.

18. The system of claim 15 wherein the executable control software:
wirelessly receives, via the transceiver, an appointment request from a plurality of visitor devices substantially simultaneously;
processes the appointment requests substantially simultaneously;
wirelessly transmits, via the transceiver, a message with available appointment times to at least some of the plurality of visitor devices substantially simultaneously;
wirelessly receives, via the transceiver, an approval request from at least some of the plurality of visitor devices substantially simultaneously; and
wirelessly transmits, via the transceiver, an approval confirmation message to at least some of the plurality of visitor devices substantially simultaneously.

19. The system of claim 15 further comprising a database of available appointment times for employees of a building.

20. The system of claim 15 wherein the executable control software transmits, via the transceiver, the approval request to an employee device and receives, via the transceiver, an approval confirmation from the employee device before wirelessly transmitting, via the transceiver, the approval confirmation message to the visitor device.
